(19) United States
(12) Patent Application Publication
(10) Pub. No.: US 2007/0007965 A1
(43) Pub. Date: Jan. 11, 2007

(54) Method and apparatus for detection and logging of buried objects and subterranean anomalies

(76) Inventor: Timothy J. Williams, Chauvin, LA (US)

Correspondence Address: Ted M. Anthony, Suite 1200, 600 Jefferson Street, Lafayette, LA, 70501, US

(21) Appl. No.: 11/202,789

(22) Filed: Aug. 12, 2005

Related U.S. Application Data
(60) Provisional application No. 60/601,031, filed on Aug. 13, 2004.

(51) Int. Cl. G01V 3/08

(52) U.S. Cl. 324/326

(57) ABSTRACT

A method and apparatus for the detection of buried objects and subterranean anomalies using detector technology including, for example, existing metal detector technology is provided. A grid having defined coordinates is established over a desired search area, and a survey is conducted over the desired search area using a metal detector. Output data generated by the metal detector are assigned values, and such values are correlated to the various coordinates of the search area. A converter is used to convert an audible analogue signal of existing metal detectors to digital values. Such digital values are then plotted against coordinates of the search area in order to develop a graphical representation or map of the search area. The graphical representation can be used, together with other information from the metal detector, to discern qualitative characteristics of buried objects and/or subterranean anomalies encountered in the search area.

### CROSS REFERENCES TO RELATED APPLICATIONS

This application claims the benefit of provisional patent application Ser. No. 60/601,031 filed Aug. 13, 2004.

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention relates to a method and apparatus for the detection of buried objects and/or subterranean anomalies. More particularly, the present invention relates to a method and apparatus for logging defined areas for the detection of buried objects and/or subterranean anomalies. More particularly still, the present invention pertains to a method and apparatus for identifying certain characteristics of buried objects and/or subterranean anomalies.

2. Description of the Prior Art

Existing metal detectors generally consist of a few basic components. Such components typically include a control box, a search coil, a shaft and a stabilizer. In most cases, a control box typically contains circuitry, controls, a speaker, batteries and a microprocessor. A search coil, sometimes referred to as a “search head,” “loop” or “antenna,” actually senses the existence of metal. A shaft connects the control box to the coil, while the stabilizer is used to keep the unit steady as it is swept back and forth over an area being surveyed. Many existing metal detectors also have a jack for connecting headphones to the unit so that an operator can hear an output signal from the metal detector.

Generally, existing metal detectors utilize one of three basic and well-established technologies: (1) very low frequency (“VLF”) technology; (2) pulse induction (“PI”) technology; and (3) beat-frequency oscillation (“BFO”) technology. VLF technology (also known as induction balance) is probably the most popular metal detector technology currently in use, while PI-based metal detectors are much common. Metal detectors employing BFO technology are often very inexpensive to manufacture, but such metal detectors typically do not provide the level of control or accuracy provided by VLF or PI systems.

In most cases, regardless of the detector technology being employed, an operator will typically perform a survey over a defined area. In the survey, an operator will pass over a defined search area moving a metal detector coil (search head) back and forth across the ground in a sweeping motion. When the coil passes over a target object, a signal is emitted by the metal detector; in most cases, the signal is an audible alarm. However, the signal can be expressed any number of different manners such as, for example, via a visual alarm or digital read-out display.

Existing metal detectors generally do not give any indication regarding the shape, configuration or other characteristics of a buried object. Some advanced metal detectors purport to identify the type of metal detected, the depth at which an object is located and/or the existence of subsurface anomalies. Unfortunately, the performance of such detectors often leaves much to be desired. Ground penetrating radar technology can achieve some of these objectives; however, such ground penetrating radar units are typically very expensive and can frequently be complicated to use.

Thus, there is a need for a proven, reliable means of utilizing search technology, including existing metal detector technology, to log a defined area for the detection of buried objects and/or subterranean anomalies and, further, for identifying qualitative characteristics regarding such buried objects and/or subterranean anomalies.

### SUMMARY OF THE INVENTION

The present invention comprises a method and apparatus for the detection of buried objects and subterranean anomalies using search technology including, for example, existing metal detector technology.

In accordance with the method of the present invention, a desired search area is identified. A starting point is established and assigned a set of coordinates. Similarly, coordinates are also assigned over the desired search area according to a predetermined pattern or grid. In the preferred embodiment, a search is conducted over the identified search area using a metal detector. Output data generated by the metal detector are assigned values, and such values are correlated to the corresponding coordinates of the search area.

In the case of most existing metal detectors, output data is expressed in the form of an audible alarm signal. Thus, in the preferred embodiment, a microprocessor converter is used to convert an audible analogue signal to a digital value. However, it is to be observed that other forms of output can also serve this function. For example, certain metal detectors express output data in the form of digital values. Such digital values are stored and plotted against corresponding coordinates of the identified search area in order to develop a graphical representation or map of the search area.

In the preferred embodiment, contouring or other software can be used to generate a desired output format. In most cases, such output will be in the form of a graphical representation of the search area. Such a graphical representation can be used, together with other information from the detector, to discern qualitative characteristics of buried objects and/or subterranean anomalies encountered during the survey.

### BRIEF DESCRIPTION OF THE DRAWINGS

FIG. 1 depicts a side view of the logging apparatus of the present invention.

FIG. 2 depicts a perspective view of the apparatus of the present invention.

FIG. 3 depicts a typical search area grid of the method of the present invention.

FIG. 4 depicts a sample graphical representation generated in accordance with the method of the present invention.

### DETAILED DESCRIPTION OF THE PRESENT INVENTION

The present invention comprises a method and apparatus for the detection of buried objects and subterranean anomalies using detector technology including, for example, existing metal detector technology.

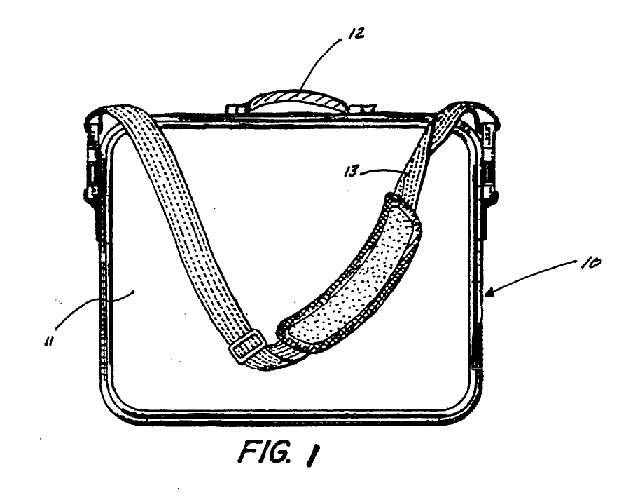

Referring to the drawings, FIG. 1 depicts a side view of logging unit 10 of the present invention. In the preferred embodiment, logging unit 10 of the present invention comprises durable external case 11 having handle 12 and optional support strap 13.

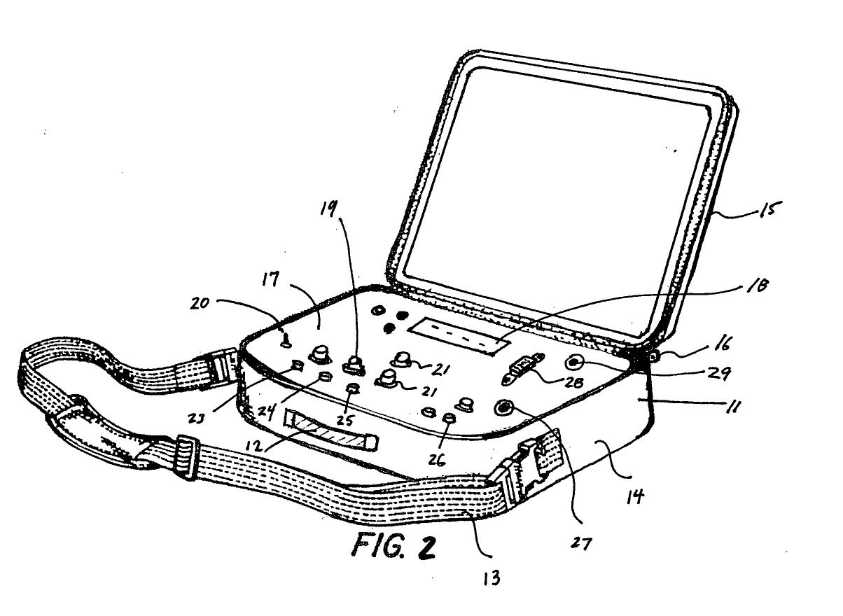

FIG. 2 depicts a perspective view of logging unit 10 of the present invention. Durable external case 11 comprises base 14 and lid 15. Said base 14 and lid 15 are joined by hinge unit 16. Control panel 17 is contained within base 14.

Control panel 17 of logging unit 10 includes a number of beneficial features. Although said control panel 17 can have any number of different configurations, in the preferred embodiment control panel 17 includes the following features:
illuminated display screen 18, for displaying coordinate information, logging status and/or other job information;
grid control switch 19, for setting the coordinates of a desired search area grid;
manual/automatic mode switch 20, for setting logging unit 10 to manual or automatic mode;
x, y adjustment switch 21, for adjusting grid coordinates;
input signal sensitivity switch 22, for adjusting the sensitivity of a signal received from a metal detector, or other similar device;
log button 23, for manually logging data at a point on a search grid;
delete button 24;
download button 25;
erase button 26;
signal input jack 27;
computer link 28; and
battery charge jack 29.
   Although not depicted in FIG. 2, logging unit 10 also includes a microprocessor or other similar data storage and processing unit to allow for the input, storage and output of data.

While the aforementioned features are included in the preferred embodiment of logging unit 10 of the present invention, it is to be observed that certain of these features can be deleted from logging unit 10 without departing from the overall scope of the present invention. Similarly, other features can be added to said apparatus without departing from the meaning or scope of said invention.

In the preferred embodiment, logging unit 10 can be easily and effectively used in tandem with existing detector units, such as metal detector units, when conducting a survey over a given search area. In such embodiment, logging unit 10 can be beneficially maintained in a convenient yet easily accessible position during a survey process. In many cases, an operator may find it beneficial to position logging unit 10 so that it rests against the operator's chest. In this position, logging unit 10 can be held in a secure position against an operator's chest by draping support strap 13 over said operator's neck, which permits the operator to clearly see the features of logging unit 10 and easily access controls of said unit during the survey.

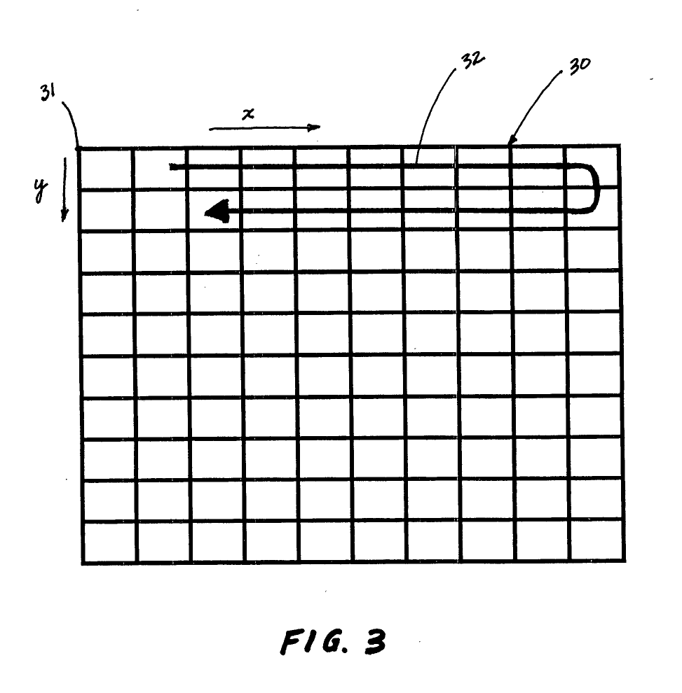

FIG. 3 depicts a sample search area grid 30 of the present invention. In accordance with the method of the present invention, said search area grid 30 is initially defined over an area to be searched. Starting point 31 is first established, and assigned coordinates along perpendicular x and y axes. In the preferred embodiment, starting point 31 is assigned coordinates x=0, y=0. A corresponding grid of x and y coordinates is thereafter established over the entire search area grid 30.

According to the method of the present invention, search area grid 30 is surveyed using a metal detector. Referring to FIG. 3, the survey is conducted in an orderly and systematic manner. In the preferred embodiment, the survey is performed along the path represented by arrow 32, and is conducted until the entire area is surveyed. In the preferred embodiment, prior to conducting such a survey, markers are laid out in the form of a grid. By way of example, but not limitation, a defined search area can be divided into one foot by one foot squares, or such other shapes or dimensions as may be desired. Generally, the higher the density of the grid, the higher the resolution of the search results.

During the survey, output data generated by a metal detector are correlated to the various coordinates of the search area grid. When such output data are expressed in the form of digital values, said data can simply be correlated directly to the corresponding coordinates of search area grid 30. Alternatively, when output data is expressed in the form of an audible alarm or other analogue signal, such output data are assigned values. Values obtained during the survey are then correlated to the corresponding coordinates of search area grid 30.

According to one method of the present invention, a metal detector is connected to logging unit 10 of the present invention via signal input jack 27. As an operator conducts a survey over search area grid 30, the operator manually correlates logging of output data received from the metal detector to corresponding positions on search area grid 30. For example, while conducting a survey along search area grid 30, an operator can manually store output data to logging unit 10 at desired points along said grid. Each time that an operator passes a desired point on the grid, the operator presses a manual log button 23 to manually store the metal detector output value at such grid position to the logging unit of the present invention.

According to another method of the present invention, data correlation is achieved pursuant to a predetermined sampling frequency; the operator adjusts the speed and progression of the survey to coincide with a predetermined sampling rate. Morever, it is to be observed that such output data can also be correlated to the grid pattern in any number of different ways. For example, such data correlation can be achieved using global positioning satellite (“GPS”) technology. Additionally, a “blanking” function is provided to account for obstructions (such as, for example, trees, buildings, etc.) that may exist within the desired search area.

In the case of most existing metal detectors, output data is expressed in the form of audible alarm signals. Thus, in the preferred embodiment, a converter is included in logging unit 10 and is used to convert audible analogue signals to digital values. However, it is to be observed that other forms of output can also serve this function. For example, in the case of metal detectors having digital output capability, such conversion is typically not required, and digital values can be stored directly to the logging unit 10 of the present invention at corresponding points along search area grid 30.

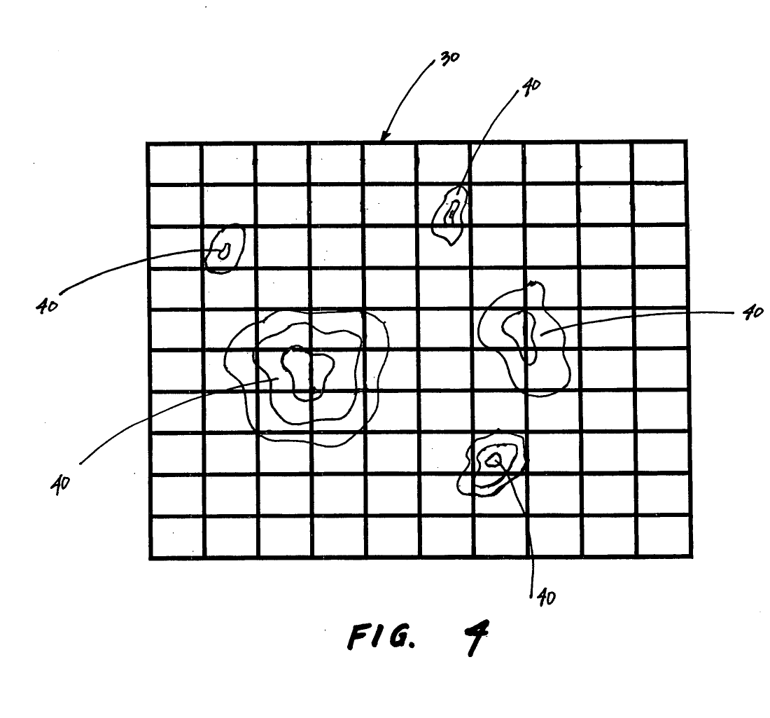

Output values collected and saved to the apparatus of the present invention can be plotted against coordinates of a search area grid in order to develop a graphical representation or map of the search area. Such information can be downloaded from logging unit 10 to a computer via computer link 28. The data can then be utilized by plotting software including, for example, commercially available software such as Snuffler™, ArcheoSurveyor™ or other similar programs to generate a desired graphical representation of an area logged in accordance with the present invention. Although such graphical representation can take any number of formats, FIG. 4 depicts one type of graphical representation that can be generated according to the method and apparatus of the present invention. In FIG. 4, target objects 40 are shown on said graphical representation.

Certain metal detectors can provide information regarding the type of metal encountered and/or subsurface anomalies. A graphical representation generated pursuant to the present invention can be used, together with other information from the metal detector, to more accurately identify the location of targets and discern qualitative characteristics of buried objects and/or subterranean anomalies encountered in the search area. For example, information regarding the type of metal encountered or the burial depth can also be included on such graphical representation to further aid in the evaluation of the search results.

The various components of the present invention are described in the form of a separate apparatus that can be used in tandem with metal detectors. However, it is to observed that such components could be incorporated directly into a metal detector, thereby eliminating the need for a separate apparatus.

The above disclosed invention has a number of particular features which should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of logging a search area with a metal detector comprising:
a. establishing a two dimensional grid having coordinates over at least part of said search area;
b. surveying said grid with a metal detector;
c. correlating output data generated by said metal detector to corresponding locations on said grid; and
d. storing said output data.

2. The method of claim 1, further comprising the step of generating a graphical representation of said output data in correlation to said grid.

3. The method of claim 2, further comprising the step of plotting data regarding the depth of buried objects or subterranean anomalies encountered during said survey on said graphical representation.

4. The method of claim 2, further comprising the step of plotting data regarding the composition of buried objects encountered during said survey on said graphical representation.

5. An apparatus for logging a search area with a metal detector comprising:
a. a port for receiving data from a metal detector;
b. means for correlating said data from said metal detector to corresponding locations within said search area; and
c. means for storing said data.

6. The apparatus of claim 5, further comprising an output port for downloading said stored data to a computer.

7. The apparatus of claim 5, further comprising means for converting analogue data received from said metal detector to digital values.

8. The apparatus of claim 5, wherein said means for correlating said data from said metal detector to corresponding locations within said search area comprises a switch actuated by an operator while surveying said search area with said metal detector.

9. The apparatus of claim 5, further comprising a durable outer case.

10. The apparatus of claim 9, further comprising a strap affixed to sad durable outer case.
